(19) United States
(12) Patent Application Publication
(10) Pub. No.: US 2026/0163166 A1
(43) Pub. Date: Jun. 11, 2026

(54) BATTERY MODULE ASSEMBLY AND ASSEMBLY METHOD FOR A BATTERY MODULE ASSEMBLY

(71) Applicant: DEUTZ Aktiengesellschaft, Cologne (DE)

(72) Inventors: Oliver Günther Hoffmann, Grafschaft (DE); Michael Sachser, Wermelskirchen (DE)

(21) Appl. No.: 19/398,182

(22) Filed: Nov. 24, 2025

(30) Foreign Application Priority Data
Nov. 28, 2024 (DE) 10 2024 135 138.1

(51) Int. Cl. H01M 50/298; H01M 10/42; H01M 50/204; H01M 50/244; H01M 50/262; H01M 50/51

(52) U.S. Cl. CPC H01M 50/298; H01M 10/425; H01M 50/244; H01M 50/262; H01M 50/51; H01M 2010/4271; H01M 50/204

(57) ABSTRACT

Battery module assembly with a first battery module and a second battery module, each comprising one or more battery cells, a battery monitoring unit, a retaining element with a receptacle in which the battery monitoring unit is arranged, wherein the retaining element is arranged between the first battery module and the second battery module, a cabling plate supported in a form-fitting manner on the retaining element with guides for holding cables of a low-voltage cabling for the battery monitoring unit.

The invention relates to a battery module assembly with a battery monitoring unit and an assembly method for a battery module assembly.

Such battery module assemblies are used to merge the electrical energy of several battery modules. At least two battery modules can be arranged in one housing for this purpose. The housing can also accommodate other components, such as cable harnesses or battery monitoring electronics.

DE 11 2020 000 386T5, for example, shows an electric battery with several electricity storage cells arranged inside a sealed compartment. The sealed compartment is filled with a dielectric fluid. The battery has at least one fluid guide made of low-density plastic, which is arranged inside the sealed compartment and defines at least one flow channel for the dielectric fluid in contact with the electricity storage cells.

CN 2 21 201 326 U discloses a battery and a vehicle. The battery comprises a first battery module, a second battery module and a partition beam arranged between the first battery module and the second battery module, as well as a heat management component and a connecting pipe.

An object of the present invention is to provide a battery module assembly and an assembly method for a battery module assembly which enable simple and rapid assembly.

To achieve the object a battery module assembly with a first battery module and a second battery module, each comprising one or more battery cells is proposed. The battery module assembly has a battery monitoring unit and a retaining element with a receptacle in which the battery monitoring unit, particularly a circuit board of the battery monitoring unit, is arranged. The retaining element is arranged between the first battery module and the second battery module and a cabling plate with guides for holding cables of a low-voltage cabling for the battery monitoring unit is supported in a form-fitting manner on the retaining element.

By using a cabling plate with guides to hold the cables of the low-voltage cabling that is supported in a form-fitting manner on the retaining element, it is possible to dispense with adhesive bases, for example, which have to be attached to the retaining element and/or the battery modules after a time-consuming cleaning process. The cabling plate can be manufactured to fit the battery modules so that the guides are optimally designed for guiding the cables of the low-voltage cabling on the cabling plate. The form-fit support of the cabling plate on the retaining element enables fast yet reliable installation, as it eliminates the time-consuming cleaning required for gluing adhesive bases or the like. This also allows the cabling plate to be quickly and easily attached to the retaining element and/or the battery modules.

The battery module assembly refers to an assembly with at least a first battery module and a second battery module. In this context, a battery module is understood to be a structural unit that has one or more battery cells connected in series or in parallel. In addition to the battery cells, a battery module can also have electrical connections, cooling components or mechanics for battery cell mounting.

A battery module can have an essentially cuboid basic shape, i.e. the basic shape can also have slight deviations, for example recesses or elevations on edges, corners or side surfaces. Furthermore, a battery module can have two longitudinal sides arranged at a distance from each other. A top side arranged transversely to the longitudinal sides, in particular perpendicular to the longitudinal sides, can be arranged at a distance from a bottom side. The bottom side can be arranged transversely to the longitudinal sides and/or parallel to the top side. In addition, the battery module can have a transverse side arranged transversely, in particular perpendicular to the longitudinal sides, the top side and/or the bottom side. The battery module can also have two transverse sides arranged at a distance from each other.

The battery monitoring unit can have a circuit board that is arranged in the receptacle of the retaining element. One or more electronic components, such as connections for electronic connections for low-voltage cabling, can be arranged on the circuit board. The battery monitoring unit can be connected to several sensors, for example sensors for monitoring the temperature, sensors for monitoring the voltage and/or sensors for monitoring other parameters. The sensors can be arranged on the battery modules and connected to the circuit board.

The retaining element, the cabling plate and/or a possible side element can each be flat components, i.e. such a component has a length and width which have an extension in the length and width direction which corresponds to a multiple of the thickness of the component. In this context, the longitudinal direction can be understood as a direction along the length of the component, i.e. in the direction along a longitudinal axis of the component, and the width direction can be understood as a direction along the width of the component. A transverse direction of the component describes a direction along a thickness of the component.

The retaining element can be arranged between a longitudinal side of the first battery module and a longitudinal side of the second battery module. The battery modules can be arranged in such a way that a gap is formed between the battery modules. The gap can be formed between two facing longitudinal sides of the battery modules. The retaining element can be arranged between the battery modules, in particular in the gap formed between the longitudinal sides of the battery modules. The retaining element can have a recess as a receptacle into which the circuit board is inserted. The circuit board can be arranged in the recess in a direction from the first battery module to the second battery module and/or vice versa without any protrusion, so that the retaining element can be pre-assembled in the gap between the battery modules.

The circuit board can be fixed in the receptacle, in particular the recess, by form and/or force fit. In particular, the circuit board can have one or more, for example two, laterally protruding protrusions. The recess of the retaining element can have lateral recesses for the protrusions. The protrusions and/or the recesses can be designed in such a way that a form-fit is formed between the circuit board of the battery monitoring unit and the retaining element in the longitudinal direction and/or in the width direction of the retaining element. The length and width can each define side surfaces of the retaining element. The thickness of the retaining element can be defined by the distance between the side surfaces of the retaining element.

Furthermore, the circuit board can be attached to the retaining element with one or more fastening elements. The protrusions can have openings for the fastening elements to pass through. The fastening element can be designed as an expansion dowel with a spring-loaded expansion section. The expansion section can be arranged in a hole of the retaining element, in particular on the recess.

The cabling plate can be arranged on a top side of at least one of the battery modules that runs transverse to the longitudinal sides. In particular, the cabling plate can be arranged on the upper sides of both battery modules. The cabling plate is also supported in a form-fitting manner on the retaining element. In particular, the cabling plate can be form-fittingly supported on the retaining element in such a way that a form-fit is formed in the longitudinal direction, i.e. also in the direction of a longitudinal axis of the cabling plate, and/or in the width direction.

The cabling plate has several guides for holding cables of the low-voltage cabling. The guides can be arranged on the cabling plate in such a way that the battery monitoring unit and/or the battery modules are connected to the cables of the low-voltage cabling for the battery monitoring unit. The guides are designed in such a way that the cables of the low-voltage cabling are detachably secured. In particular, the guides can be designed in such a way that the cables are held in place in a form-fitting manner. A form-fit can be formed between the guides and the cables in the transverse direction of the cabling plate. Low-voltage cabling refers to a cabling system for voltages below the standard mains voltage of 230 V, for example voltages with a value between 5 and 50 V or 5 and 25 V. The cables can form a cabling harness for low-voltage cabling.

According to an embodiment, the retaining element can have a shoulder on a top side facing the cabling plate for form-fit support of the cabling plate on the retaining element. The shoulder can protrude from the top in the direction of the width of the retaining element. The cabling plate can have a recess for positioning the shoulder. The shoulder of the retaining element and/or the recess in the cabling plate can be designed in such a way that the shoulder is supported laterally in the recess in the longitudinal direction of the retaining element. In particular, the shoulder can be arranged in the recess in such a way that at least a form-fit is formed in the transverse direction of the cabling plate. The shoulder and/or the recess can each have a polygon-shaped, for example square, cross-section transverse to the longitudinal axis of the cabling plate. The retaining element may have been manufactured in one piece so that the shoulder is formed in one piece on the top side of the retaining element. The shoulder on the top of the retaining element enables the cabling plate to be supported form-fittingly on the retaining element in a simple and compact way.

According to an embodiment, the cabling plate can have at least one lateral support element for supporting on at least one battery module, particularly the two battery modules. In this context, lateral can be understood to mean that the support element is arranged on a side surface of the cabling plate. The side surfaces of the cabling plate can be arranged at a distance from each other in the width direction of the cabling plate. The support element can be formed in one piece on the cabling plate. In addition, the support element can be formed on a first side surface of the side surfaces in the direction along the longitudinal axis of the retaining element.

In a top view of the cabling plate, the support element can be axially symmetrical to the longitudinal axis of the retaining element. For example, the support element can have a web projecting from the first side surface in the direction along the longitudinal axis of the retaining element and/or in the width direction of the cabling plate. In addition, the support element can have two support sections projecting laterally from the web at right angles to the longitudinal axis of the retaining element. The support element, in particular the web and the support sections, can have the same thickness as the rest of the cabling plate. Several support elements can also be provided. For example, a further support element can be arranged on a second side surface opposite the first side surface. The support elements can be designed differently but may also be identical. The additional support element or support elements can further secure the cabling plate against unwanted displacement or movement in the longitudinal and/or width direction of the cabling plate and further improve the hold of the cabling plate by additionally supporting it on the battery modules.

According to an embodiment, at least one, particularly two, side elements can be arranged on a transverse side of at least one of the battery modules extending transversely to the longitudinal sides and the top side. The at least one side element can be supported in a form-fitting manner against the retaining element. The retaining element can be supported laterally on two side elements to form an H-profile. The side elements may each have a coupling section for form-fitting connection with form-fitting sections of the retaining element. The side elements and the retaining element can form an H-profile in the top view of the cabling plate and/or in the transverse direction of the retaining element.

A side element can be designed as an elongated component. Furthermore, the side elements can extend in lengths of at least 50%, at least 75% or the entire length of the cabling plate. In particular, the side elements can be designed identically. Furthermore, the side elements can be designed and/or arranged in a top view of the cabling plate to be axially symmetrical to the longitudinal axis of the cabling plate. The coupling sections of the side elements can each be arranged on an inner side facing the retaining element. The retaining element can have two form-fitting sections, each assigned to one of the side elements. The form-fitting sections can be arranged on two opposite front faces of the retaining element. The front faces indicate the end cross-sections of the retaining element. Preferably, the coupling sections can be arranged in the area of the retaining element, in particular in the area of the longitudinal axis of the retaining element.

The coupling sections and/or the form-fitting sections can be designed in such a way that a form-fit is created between the retaining element and one of the side elements in the direction along the longitudinal axis of the cabling plate. The coupling sections and/or the form-fitting sections can each be axially symmetrical to a main axis arranged perpendicular to the longitudinal axis of the retaining element. In particular, the coupling sections and/or the form-fitting sections can be designed in such a way that the side elements are pushed onto the retaining element from the top side in the direction of a bottom side of the retaining element, based on the position of use of the battery module assembly. This can also create a form-fit between the retaining element and the side elements in the direction of the bottom side of the retaining element. For example, the form-fit can be created from a coupling section and a form-fitting section by means of a tongue-and-groove connection. The coupling sections can each be designed as a tongue and the form-fitting sections can each be designed as a groove or vice versa. In this case, the spring can designate a section of the retaining element that protrudes from the front face of the retaining element.

The side elements can each have a reinforcing rib in the area of the coupling sections. The reinforcing rib can protrude in the direction of the retaining element. Alternatively, or additionally, the reinforcing rib can be adapted to the gap between the battery modules. For example, the reinforcement rib in the top view of the cabling plate has a length that corresponds to the thickness of the retaining element. The side elements and the possible design for a form-fit connection of the retaining element to the side elements enable even faster assembly of the battery module assembly. In addition, the form-fit connection between the retaining element and the side element or side elements means that unwanted movement of the retaining element in the longitudinal direction of the cabling plate can be easily and reliably prevented.

According to an embodiment, the cabling plate can be arranged on the top side of the retaining element and the side element on transverse sides, in particular the front faces of the retaining element, in relation to the position of use. In the position of use, the bottom side and/or the top side of the retaining element can be arranged parallel to a base plane of the battery module assembly. The cabling plate can rest on the top side of the retaining element in such a way that a support surface and/or an outer surface of the cabling plate are arranged parallel to the base plane. The side elements can be arranged on the transverse side of the retaining element in such a way that the inside and/or outside of the side elements are each arranged transversely, in particular perpendicular to the base plane. The retaining element can be arranged between the side elements in the direction of the longitudinal axis of the retaining element. The possible arrangement of the retaining element, the cabling plate, and the side elements in relation to the position of use of the battery module assembly enables a particularly compact and stable design for the battery module assembly, even with quick and easy assembly.

According to an embodiment, the at least one side element, particularly the side elements, can have at least one receptacle, in particular a groove, on an outer side facing away from the retaining element for inserting a busbar for a high-voltage connection between the battery modules. The outside of the side element can face away from the inside. The receptacle can be designed as a groove. The receptacle can be arranged or designed on the outside in such a way that the bus bar can be inserted into the receptacle from a top side and/or a front face, i.e., from the direction of a front face of the side element.

In particular, the side element can have one or more ribs on the outside to reinforce the side element. Several ribs can be arranged at intervals in the direction of the longitudinal axis of the cabling plate and/or in the direction of a longitudinal axis of the side element. The receptacle of the side element may be formed in a top view on the outside of a side element behind the rib element or rib elements. For example, the receptacle is a free section of the side element between the inside and the outside of the side element, in particular the rib or ribs. The busbar for the high-voltage connection can be arranged in the receptacle and connected to the battery modules via electrical connectors, e.g. plugs, and also screwed to the battery modules. The battery modules can be connected in series via the busbar. The busbar can be made of a conductive material, such as metal.

The receptacle of the side elements allows the busbar for the high-voltage connection to be fixed easily and reliably. In addition, there is no need for time-consuming adhesive bases to secure the busbar, which makes installation of the battery module assembly even faster. The ribs can be compressed to compensate for tolerance when mounting the side elements in a tray housing of the battery module assembly and also serve to securely fasten the side elements in the tray housing.

According to a possible embodiment, the guides of the cabling plate can be designed in such a way that the cabling plate is essentially flat on a support surface facing the retaining element and the battery modules and on an outer surface facing away from the support surface in order to enable an even more compact design of the battery module assembly. The support surface and the outer surface are arranged at a distance from each other in the transverse direction of the cabling plate. The distance between the support surface and the outer surface defines the thickness of the cabling plate. In this context, essentially flat is understood to mean that the cabling plate has no protrusions or elevations protruding from the support surface and/or the outer surface, at least along the guides. The cabling plate can be flat except for the elevation of the support surface in the area of the retaining element. In particular, the outer surface of the cabling plate can be completely flat.

Preferably, the guides of the cabling plate can each be designed as grooves in the cabling plate. Along the grooves, several spaced-apart locking elements can be arranged to form-fittingly hold the cables, which protrude beyond the grooves. In this context, a groove is understood to be a free section of the cabling plate that is limited by a bottom and two side walls for guiding the cables. The grooves may be designed to be wave-shaped, at least in sections, whereby the locking elements may be designed to be located on an arc of the wave-shaped sections. In particular, the locking elements can be designed as arches projecting from the side walls of the groove. The cables can be pressed into the groove in such a way that the cables engage behind the locking elements and thus form a form-fit in the width direction of the retaining element. The possible design of the guides as grooves in conjunction with the locking elements means that the cables of the low-voltage cabling can be guided and held in position easily and tailored to the application.

According to an embodiment, the cabling plate can have at least one recess to accommodate an electrical connector for the low-voltage cabling. Preferably, the cabling plate can have three recesses for the passage of electrical connectors, e.g., plugs of the low-voltage cabling, which are arranged at a distance from each other in the direction of a longitudinal axis of the retaining element. The electrical connectors can be transfer plugs on the battery monitoring unit, for example. Depending on the type of electrical connector, the recesses can be designed differently or, if necessary, identically. For example, the recesses can differ in size and shape. The fact that the cabling plate has one or more recesses for the electrical connectors of the battery monitoring unit means that the battery monitoring unit can be cabled quickly and reliably. In addition, the recesses and any grooves for connecting the recesses to each other enable an even more compact design for the battery module assembly, as the cables and connectors can be mounted or held on or in the cabling plate to save space.

Holes for fixing cable ties can be drilled in the cabling plate to improve accessibility in the area of the connectors and to hold the cables to the connectors. If there are two or more recesses, one or more holes may be provided for fixing cable ties to a groove formed between two adjacent recesses. In addition, through-openings with material tapers surrounding the through-opening can be arranged at the edges of the recesses. The through-openings penetrate the cabling plate from the outer surface to the support surface. Furthermore, the through-openings can be arranged in pairs on opposite edges of a recess. In conjunction with the corresponding material tapers, the through-openings allow cable ties to be attached to additionally secure the cables in the connector area. Furthermore, through-openings can be arranged at other positions on the cabling plate, in particular at positions of low material thickness, which prevents the cables from being fixed in place with a form-fit.

According to an embodiment, the battery module assembly can have a third battery module. A further retaining element with a battery monitoring unit can be arranged between the second battery module and third battery module. The cabling plate can be supported in a form-fitting manner on both retaining elements. The third battery module can be arranged at the same distance from the second battery module as the second battery module is from the first battery module. Alternatively, the third battery module can also be arranged next to the first battery module so that the additional retaining element is arranged between the first battery module and the third battery module. The two retaining elements can be designed identically.

The cabling plate can also be supported in a form-fitting manner on the other retaining element. The cabling plate can also have a length adapted to the length of the battery modules arranged next to each other. In addition, the cabling plate can have further guides for the cables connected to the battery monitoring unit on the further retaining element.

The side elements can have further coupling sections for form-fitting connection to the other retaining element. Furthermore, the length of the side elements can be adapted to the length of the battery modules arranged next to each other.

It is also possible that more than three battery modules are arranged in series along a longitudinal axis of the battery module assembly. In this case, the cabling plate and the side elements can be designed for either two or three battery modules. Accordingly, two or more cabling plates and/or two or more side elements can also be arranged in a row along the longitudinal axis of the battery module assembly, particularly a longitudinal axis of the tray housing, at a distance from each other.

According to an embodiment, the cabling plate can have a positioning element in an edge area for aligning a cable loop of the low-voltage cabling with an opening in a cover arranged above the cabling plate. In this context, a positioning element is understood to be an element or section of the cabling plate that enables the alignment of a cable loop. The positioning element can protrude from a side surface, in particular the second side surface of the cabling plate. In particular, the positioning element can have a retaining section for holding the cable loop. The retaining section can be designed in such a way that the cable loop is detachably attached to the positioning element. In particular, the retaining section can have a hole and an inlet for the cable loop connected to the hole. Preferably, the positioning element can be designed as a web projecting from the side surface of the cabling plate with a hole and a slot tapering down to the hole in order to engage the cable loop in the hole and allow the cable loop to slide back.

The positioning element is arranged in particular in the area of the retaining element on the cabling plate. In particular, the positioning element can be arranged parallel to the longitudinal axis of the retaining element. The hole of the retaining section may be oversized compared to the cable of the cable loop. Furthermore, the positioning element can be arranged in such a way that a hole axis of the retaining section intersects the longitudinal axis of the retaining element. The positioning element enables simple and reliable alignment of the cable loop of the low-voltage cabling to an opening of a cover arranged above the cabling plate, in particular a tray housing of the battery module assembly. The positioning element allows the cable loop to be positioned centrally below the opening in the cover, preventing the cable harness of the low-voltage cabling from chafing in the opening.

According to an embodiment, a first module level can have the battery modules, retaining elements, the cabling plate and/or the side element. A second module level can be arranged on the first module level. The battery module assembly, in particular the module level, can also have a tray housing. The module levels can be designed identically. In addition, more than two module levels can be arranged on top of each other. As an alternative to the cover of the tray housing, the opening for feeding the cable of the cable loop through can also be arranged on a bottom of the tray housing of the second module level.

According to an embodiment, the retaining element, the cabling plate and/or the side element can be made of a foamed plastic. The foamed plastic can be expanded polypropylene (EPP) in particular. Foamed plastics, and EPP in particular, can be produced with sufficient tolerances and also have a certain elasticity that enables local forming with little effort. This means that the use of foamed plastics makes it easy to mount the retaining element between the battery modules with high positional accuracy over the service life of the battery module assembly. In addition, foamed plastics have a very low density, which means that their use has a significant weight advantage over metal retaining elements, for example. In addition, foamed plastics have a high damping constant, so that the retaining elements made of foamed plastic can dampen vibrations acting on the circuit board.

### The Invention Further Relates to an Assembly Method for the Battery Module Assembly Comprising

the steps of:
Mounting a first battery module and a second battery module in series along a longitudinal axis, so that a gap is formed between the first battery module and the second battery module;
Fastening the battery monitoring unit in a receptacle of a retaining element;
Insert the retaining element with the battery monitoring unit into the gap;
Fastening a cabling plate on the retaining element, wherein the cabling plate is supported in a form-fitting manner on the retaining element,
Fastening cables of a low-voltage cabling for the battery monitoring unit to guides of the cabling plate, wherein the cables are held in the guides.

When mounting the battery module assembly, the first battery module and the second battery module are first mounted in series along the longitudinal axis, for example the longitudinal axis of the tray housing, so that a gap is formed between the first battery module and the second battery module for arranging the retaining element. The gap can be formed between the first longitudinal side and the second longitudinal side. The retaining element can be arranged between a longitudinal side of the first battery module and a longitudinal side of the second battery module. The battery modules can be arranged in a tray housing, whereby the battery modules can be mounted along a longitudinal axis of the tray housing.

The battery monitoring unit is secured in the receptacle of the retaining element. The circuit board of the battery monitoring unit can be inserted from a starting position to an intermediate position from the bottom side of the retaining element into the receptacle, in particular the recess of the retaining element, in such a way that the connections of the circuit board can be reached from the top of the retaining element. In the intermediate position, an upper edge of the circuit board of the battery monitoring unit can rest against the side surface of the retaining element. To achieve a final position, the circuit board can be rotated around the upper edge in the direction of the side surface of the retaining element so that the form-fit is formed between the protrusions of the circuit board and the recesses of the retaining element. In addition, the fastening elements can be arranged in the openings of the protrusions. The retaining element is pre-assembled with the battery monitoring unit, in particular the circuit board of the battery monitoring unit, in order to be inserted between the battery modules.

The retaining element is inserted into the gap between the battery modules together with the battery monitoring unit, in particular the circuit board of the battery monitoring unit. The retaining element can be clamped between the battery modules in the gap in a force-fit manner. The distance between the facing longitudinal sides of the battery modules may be less than the thickness of the retaining element in order to clamp the retaining element in a force-fit manner.

The cabling plate can be arranged on a top side of at least one of the battery modules that runs transverse to the longitudinal sides. The cabling plate is attached to the retaining element and form-fittingly supported on the retaining element. The cabling plate can be supported on the shoulder of the retaining element in a form-fitting manner. In addition, the cabling plate can be supported by the support element on the battery modules, in particular the top sides of the battery modules. To attach the cabling plate to the retaining element, the cabling plate is adjusted in relation to the position of use from above the top side of the retaining element and the top sides of the battery modules in the direction of the retaining element and/or the battery modules until the cabling plate is supported on the shoulder of the retaining element and/or the battery modules, in particular the top sides of the battery modules.

The cables of the low-voltage cabling for the battery monitoring unit are attached to the guides of the cabling plate and held form-fittingly in the guides. The electrical connectors of the low-voltage cabling can be connected through the recesses in the cabling plate to the connections provided on the circuit board of the battery monitoring unit. The cables can also be fixed in the area of the connectors, particularly at the grooves connecting the recesses, at the through-openings using cable ties.

Before attaching the cabling plate, at least one side element can be arranged on a transverse side of at least one of the battery modules extending transversely to the longitudinal sides and the top side and can be supported against the retaining element in a form-fitting manner. The side elements can each be form-fittingly connected to the retaining element via the form-fit between the coupling sections and the form-fitting sections. For fastening to the retaining element, the side elements can be arranged in the tray housing, in particular from the direction of the top side of the retaining element, so that the coupling sections of the side element are pushed onto the form-fitting sections of the retaining element from above. The side elements can each be connected to the tray housing in a force-fit manner using the ribs on the outsides of the side elements.

Before attaching the side element, a busbar for electrically connecting the battery modules can be inserted into a receptacle of the side element arranged on an outside facing away from the retaining element. A further busbar for electrically connecting the second battery module to a possible third battery module can be arranged on the other of the side elements. The busbar can be connected to the two battery modules at electrical connectors and, in particular, screwed to the battery modules at the connectors.

The battery modules, the retaining elements, the cabling plate, and/or the side element can form a first module level, with a second module level being arranged on the first module level. A cable loop of the first module level can be aligned by the positioning element centrally below the opening of the bottom of the tray housing of the second module level. The cable of the cable loop can be routed through the opening when the second module level is arranged on the first module level.

In the following, embodiments of the invention are explained in more detail with reference to the figures. Herein

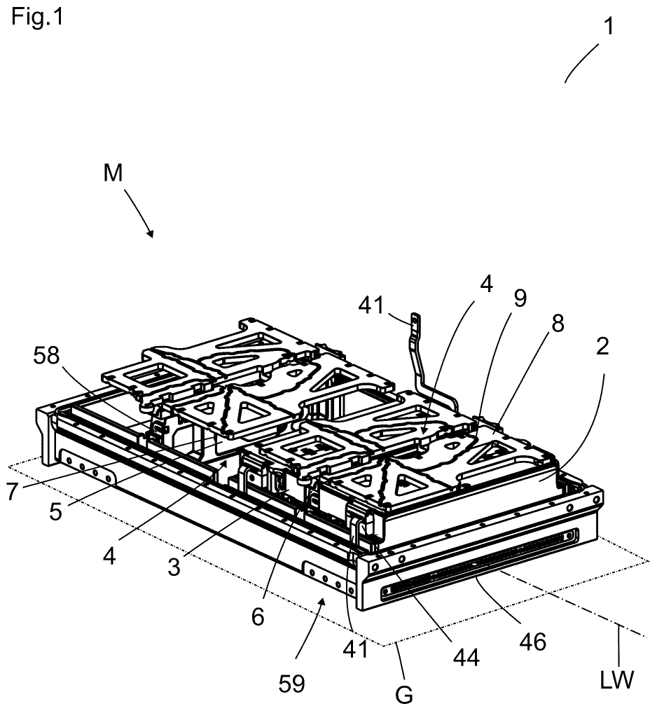

FIG. 1 shows a perspective view of a battery module assembly,

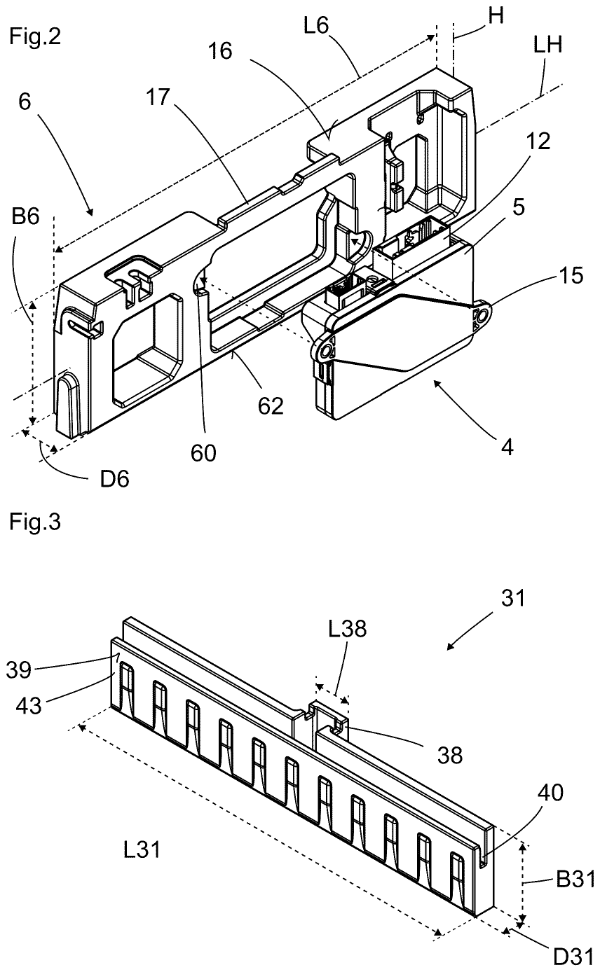

FIG. 2 shows a perspective view of a retaining element and a battery monitoring unit of the battery module assembly of FIG. 1,

FIG. 3 shows a perspective view of a side element of the battery module assembly of FIG. 1,

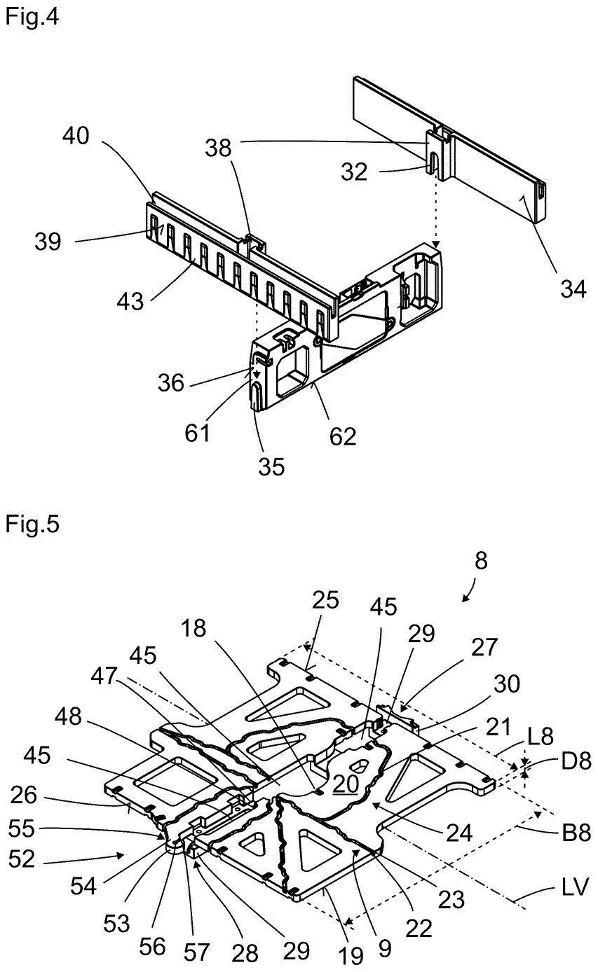

FIG. 4 shows a perspective view of a process step for arranging two side elements of FIG. 3 on the retaining element of FIG. 2,

FIG. 5 shows a perspective view of a cabling plate of the battery module assembly of FIG. 1,

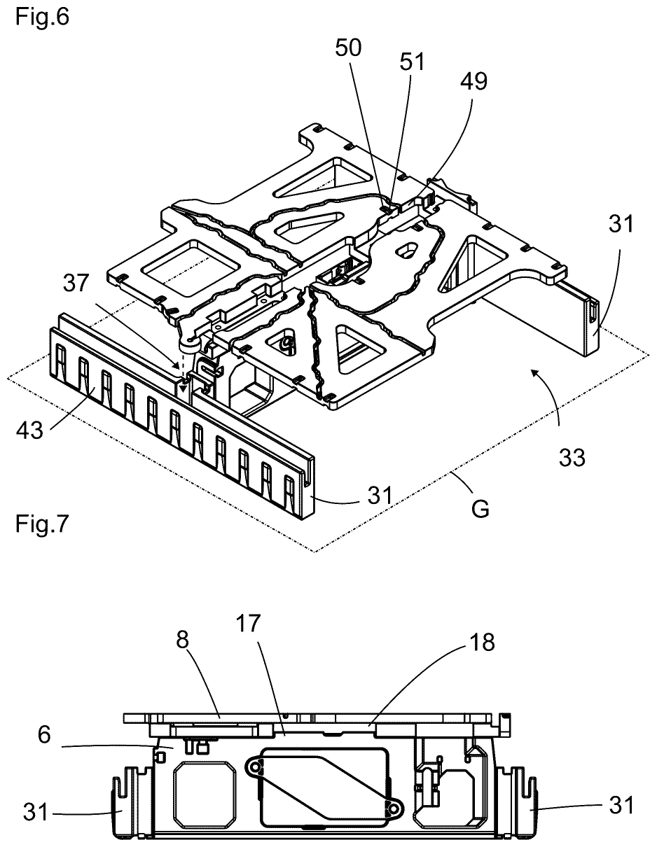

FIG. 6 shows a perspective view of a process step for arranging the cabling plate of FIG. 5 on the assembly of FIG. 4,

FIG. 7 shows a side view of the assembly in FIG. 6,

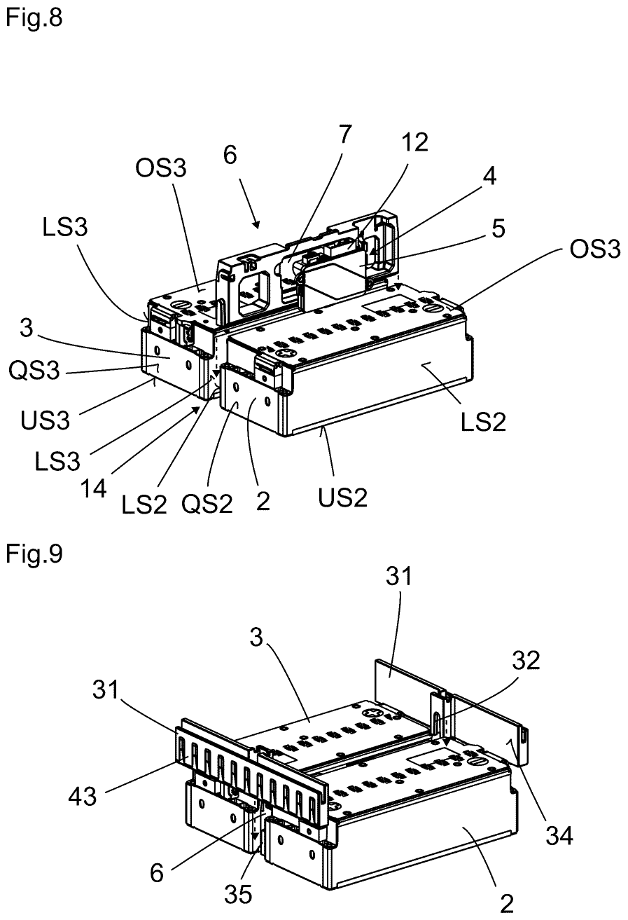

FIG. 8-13 shows steps of an assembly procedure for the battery module assembly of FIG. 1, and

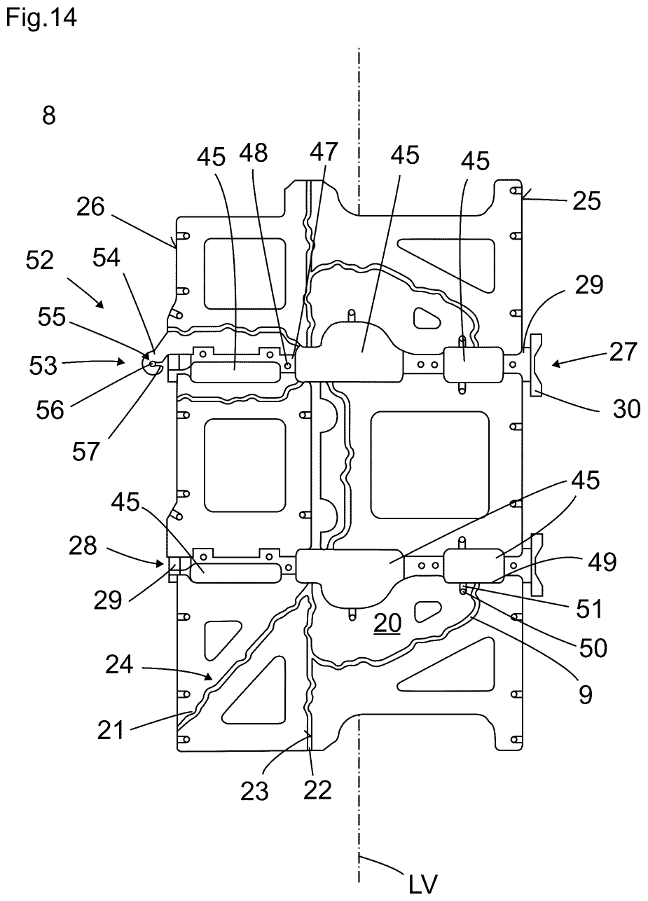

FIG. 14 shows a top view of a cabling plate of a second embodiment of the battery module assembly of FIGS. 1 to 13.

FIG. 1 shows a battery module assembly 1 with a first battery module 2 and a second battery module 3. The battery modules 2, 3 each have one or more battery cells.

The battery modules 2, 3 each have two longitudinal sides LS2, LS3 arranged at a distance from each other (see FIG. 8). A top side OS2, OS3 arranged transversely, here for example perpendicular to the longitudinal sides LS2, LS3, is arranged at a distance from a bottom side US2, US3. The bottom side US2, US3 is arranged transverse to the longitudinal sides LS2, LS3 and parallel to the top side OS2, OS3. In addition, the battery modules 2, 3 have two transverse sides QS2, QS3 arranged at a distance from each other and transversely, here for example perpendicular to the longitudinal sides LS2, LS3, the top side OS2, OS3 and the bottom side US2, US3.

The battery module assembly 1 has a battery monitoring unit 4 with a circuit board 5 and a retaining element 6 with a receptacle 7. The circuit board 5 of the battery monitoring unit 4 is arranged in the recess 7 of the retaining element 6 (see FIGS. 2, 4 and 7). The retaining element 6 is arranged between the first battery module 2 and the second battery module 3. A cabling plate 8 is supported in a form-fitting manner on the retaining element 6 with guides 9 for holding cables 10 of a low-voltage cabling 11 for the battery monitoring unit 4.

The retaining element 6, the cabling plate 8 and side elements 31 each are flat components, i.e. such a component 6, 8, 31 has a length L6, L8, L31 and width B6, B8, B31, which have an extension in the length and width direction which corresponds to a multiple of the thickness D6, D8, D31 of the component. In this context, the longitudinal direction is understood to mean a direction along the length L6, L8, L31 of the component 6, 8, 31, i.e. in the direction along a longitudinal axis of the component 6, 8, 31, and the width direction is understood to mean a direction along the width B6, B8, B31 of the component 6, 8, 31. A transverse direction of the component 6, 8, 31 describes a direction along the thickness D6, D8, D31 of the component 6, 8, 31.

As shown in FIG. 2, one or more electronic components are arranged on the circuit board 5 of the battery monitoring unit 4, here for example in the form of connections 12 for plugs 13 of the low-voltage cabling 11 for the battery monitoring unit. The battery monitoring unit 4 can be connected to several sensors, for example sensors for monitoring the temperature, sensors for monitoring the voltage and/or sensors for monitoring other parameters.

The battery modules 2, 3 are arranged relative to each other in such a way that a gap 14 is formed between the battery modules 2, 3. The retaining element 6 is arranged in the gap 14 between the longitudinal side LS 2 of the first battery module 2 and the longitudinal side LS 3 of the second battery module 3. As shown in FIG. 7, the circuit board 5 is arranged in the recess 7 in a direction from the first battery module 2 to the second battery module 3 without any protrusion. The plate 5 is form-fittingly and force-fittingly secured in the recess 7. For this purpose, the circuit board 5 has two laterally protruding protrusions 15. Lateral recesses 60 for the protrusions 15 are formed on the recess 7 of the retaining element 6. The protrusions 15 and/or the recesses 7 are designed in such a way that a form-fit is created between the circuit board 5 of the battery monitoring unit 4 and the retaining element 6 in the longitudinal direction and in the width direction of the retaining element 6.

The cabling plate is located on the top sides O2, O3 of the two battery modules 2,3. On the top side 16 facing the cabling plate 8, the retaining element 6 has a shoulder 17 for form-fit support of the cabling plate 8 on the retaining element 6. The shoulder 17 protrudes from the top side 16 in the width direction of the retaining element 6. The cabling plate 8 has an opening 18 for positioning the shoulder 17. The shoulder 17 is arranged in the opening 18 in such a way that a form-fit is formed in the longitudinal direction of the retaining element 6. The retaining element 6 has been manufactured in one piece, so that the shoulder 17 is formed in one piece on the top side 16 of the retaining element 6.

As shown in FIG. 5, the guides 9 of the cabling plate 8 are designed such that the cabling plate 8 is flat at least along the guides 9 on a support surface 19 facing the retaining element 6 and the battery modules 2, 3 and on an outer surface 20 facing away from the support surface 19, i.e. has no protrusions or elevations projecting from the support surface 19 and the outer surface 20. The support surface 19 and the outer surface 20 are arranged at a distance from each other in the transverse direction of the cabling plate 8. This distance defines the thickness D8 of the cabling plate 8. The outer surface 20 of the cabling plate 8 is completely flat.

The guides 9 are also designed in such a way that the cables 10 of the low-voltage cabling 11 are held in place in a form-fitting manner. A form-fit is formed between the guides 9 and the cables 10 in the transverse direction of the cabling plate 8. The guides of the cabling plate 8 are each formed as grooves 9 of the outer surface 20 of the cabling plate 8. Along the grooves 9, several spaced-apart locking elements 21 can be arranged to form-fittingly hold the cables 10, which protrude beyond the grooves 9. The grooves 9 are a free section on the outer surface 20 of the cabling plate 8, which is delimited by a bottom 22 and two side walls 23 for guiding the cables 10. The grooves 9 are wave-shaped, at least in sections. The locking elements are each formed as arches 21 of a wave 24 projecting from the side walls 23 of the groove 9.

The cabling plate 8 has two support elements 27, 28, each arranged on a side surface 25, 26 of the cabling plate 8, for support on the two battery modules 2, 3. A first support element 27 is formed in the direction along the longitudinal axis LH of the retaining element 6 on a first side surface 25 of the side surfaces 25, 26. In top view of the cabling plate 8, the first support element 27 is axially symmetrical to a longitudinal axis LH of the retaining element 6. The first support element 27 has a web 29 projecting from the first side surface 25 in the direction along the longitudinal axis LH of the retaining element 6 and transversely to a longitudinal axis LV of the cabling plate 8. In addition, the first support element 27 has two support sections 30 projecting laterally from the web 29 at right angles to the longitudinal axis LH of the retaining element 6. A second support element 28 is formed on a second side surface 26 opposite the first side surface 25. The support elements 27, 28 are designed differently. The second support element 28 has only one web 29.

The retaining element 6 is supported laterally on two side elements 31, as shown in FIG. 3. The side elements 31 each have a coupling section 32 for form-fitting connection to the retaining element 6. The side elements 31 and the retaining element 6 form an H-profile 33 in the top view of the cabling plate 8 and in the transverse direction of the first retaining element 6 (see FIG. 4).

The side elements 31 are identical in design and, when viewed from above, are arranged on the cabling plate 8 in a manner that is axially symmetrical to the longitudinal axis LV of the cabling plate 8. The coupling sections 32 of the side elements 31 are each arranged on an inside 34 facing the retaining element 6. The retaining element 6 has two form-fitting sections 35, each assigned to one of the side elements 31, which are arranged on two opposing front faces 36 of the retaining element 6.

The coupling sections 32 and the form-fitting sections 35 are each axially symmetrical to a main axis H arranged perpendicular to the longitudinal axis LH of the retaining element. A form-fit consisting of a coupling section 32 and a form-fitting section 35 is created by a tongue-and-groove connection 37. The coupling sections are each designed as a tongue 32 and the form-fitting sections are each designed as a groove 35.

As shown in FIG. 3, the side elements 31 each have a reinforcing rib 38 projecting in the direction of the retaining element 6 in the region of the coupling sections 32. The reinforcing ribs 38 of the side elements 31 have a length L 38 in top view of the cabling plate 8, which corresponds to the thickness D6 of the retaining element 6.

In addition, on an outside 39 facing away from the retaining element 6 and the inside 34 of the side elements 31, the side elements 31 have a receptacle in the form of a groove 40 for inserting a busbar 41 for a high-voltage connection 42 of the battery modules 2, 3. Furthermore, the side elements 31 each have several ribs 43 on the outside 39, arranged at intervals in the direction of the longitudinal axis LV of the cabling plate 8 and in the direction of a longitudinal axis LS of the side element 31. The groove 40 of the side elements 31 is formed between the inside 34 and the outside 39. The busbar 41 for the high-voltage connection 42 is arranged in the groove 40 and connected to the battery modules 2, 3 via connectors 44. In addition, the busbar 41 can be screwed to the battery modules 2, 3 at the connectors 44.

With reference to the position of use of the battery module assembly 1, shown in FIGS. 1, 6 and 13, the cabling plate 8 is arranged on the top side 16 of the retaining element 6. The side elements 31 are each arranged on transverse sides 61 of the retaining element 6 on the front faces 36 of the retaining element 6. In the position of use, a lower side 62 of the retaining element 6 and the top side 16 of the retaining element 6 are arranged parallel to a base plane G of the battery module assembly 1. The cabling plate 8 rests on the top side 16 of the retaining element 6 in such a way that the support surface 19 and the outer surface 20 of the cabling plate 8 are arranged parallel to the base plane G. The side elements 31 are arranged on the transverse side 61 of the retaining element 6 in such a way that the inside 34 and the outside 39 of the side elements 31 are each arranged transversely, here for example perpendicular to the base plane G. The retaining element 6 is arranged between the side elements 31 in the direction of the longitudinal axis LH of the retaining element 6.

The cabling plate 8 has three recesses 45, spaced apart in the direction of the longitudinal axis LH of the retaining element 6, for receiving the plugs 13 of the low-voltage cabling 11. The plugs 13 are different transfer plugs 13 on the battery monitoring unit 4. Depending on the type of plug 13, the recesses 45 are designed differently and vary in size and shape. Grooves 47 with one or more holes 48 for fixing cable ties are provided between two adjacent recesses 45.

Through-openings 50 with material tapers 51 surrounding them are arranged at the edges 49 of the recesses 45. The through-openings 50 penetrate the cabling plate 8 from the outer surface 20 to the support surface 19. Furthermore, the through-openings 50 are each arranged in pairs on opposite edges 49 of a recess 45.

In an edge area 52, the cabling plate 8 has a positioning element 53 for aligning a cable loop with an opening in a cover arranged above the cabling plate 8. The positioning element 53 is formed here, for example, as a web 54 projecting from the second side surface 26 of the cabling plate 8 with a retaining section 55, which has a hole 56 and a slot 57 tapering down to the hole 56. The positioning element 53 is arranged parallel to the longitudinal axis LH of the retaining element 6 on the cabling plate 8.

As indicated in FIG. 1, the battery module assembly 1 can have a third and a fourth battery module, which are not shown. In this case, the battery module assembly 1 can have a second cabling plate 8 and a further retaining element 58 arranged between the third and fourth battery modules. Additional side elements 31 can also be provided. The retaining elements 6, 58 the cabling plate 8 and/or the side elements 31 are made of a foamed plastic, here for example expanded polypropylene (EPP).

The battery modules 2, 3, the retaining elements 6, 58, the cabling plate 8 and/or the side elements 31 can form a first module level M. The module level M of the battery module assembly 1 can also have a tray housing 59, as shown in FIG. 1. A second module level, not shown, can be arranged on the first module level M. The module levels can be designed identically.

FIGS. 8 to 13 show steps of an assembly process for the battery module assembly 1. First, as shown in FIG. 8, the first battery module 2 and the second battery module 3 are mounted in the tray housing 59 in series along a longitudinal axis LW of the tray housing 59, so that the gap 14 for arranging the retaining element 6 is formed between the first battery module 2 and the second battery module 3. The tray housing 59 is not shown in FIGS. 8 to 13 for the sake of clarity and is only shown as an example in FIG. 1.

The battery monitoring unit 4 is secured in the recess 7 of the retaining element 6. For this purpose, the circuit board 5 of the battery monitoring unit 4 is inserted into the recess 7 of the retaining element 6 and the form-fit is formed between the protrusions 15 of the circuit board 5 and the recesses 60 of the retaining element 6. The retaining element 6 is pre-assembled with the circuit board 5 of the battery monitoring unit 4. The retaining element 6 with the battery monitoring unit 4 is then inserted into the gap 14 between the battery modules 2, 3 and clamped in the gap 14 between the battery modules 2, 3 in a force-fitting manner.

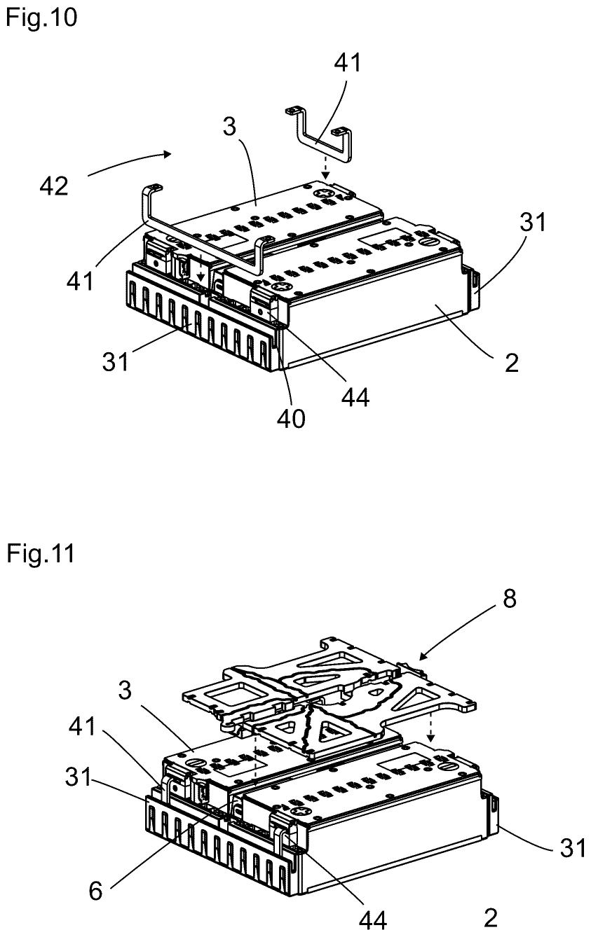

The two side elements 31 are attached to the retaining element 6, as shown in FIG. 9. The side elements 31 are form-fittingly connected to the retaining element 6 via the form-fit between the coupling sections 32 and the form-fitting sections 35. For this purpose, the side elements 31 are arranged in the tray housing 59 from the direction of the top side 16 of the retaining element 6 in such a way that the coupling sections 32 of the side elements 31 are pushed onto the form-fitting sections 35 of the retaining element 6 from above. In addition, the side elements 31 are each force-fittingly connected to the tray housing 59 by means of the ribs 43 on the outsides 39 of the side elements 31.

To electrically connect the first battery module 2 to the second battery module 3, the busbar 41 is arranged in the receptacle 40 of one of the side elements 31, as shown in FIG. 10. A further busbar 41 for connecting the second battery module 2 in series with the third battery module (not shown) is arranged on the other of the side elements 31. The busbars 41 are each connected to the two battery modules 2, 3 at the connectors 44 and, if necessary, screwed to the battery modules 2, 3 at the connectors 44.

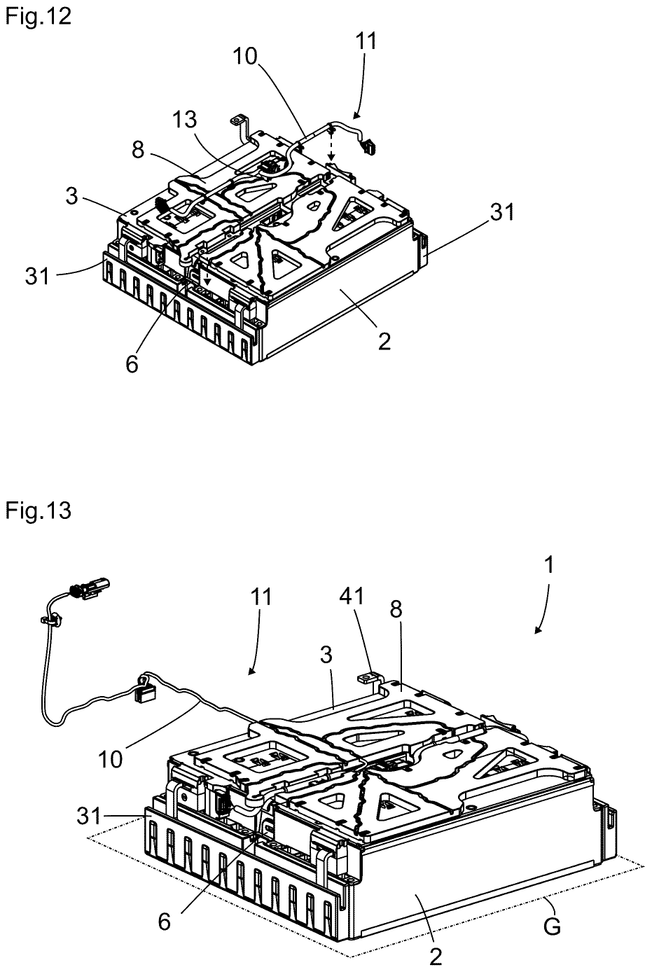

The cabling plate 8 is then attached to the retaining element 6, as shown in FIG. 11. The cabling plate 8 is supported in a form-fitting manner on the shoulder 17 of the retaining element 6. In addition, the cabling plate 8 is supported by the support elements 27, 28 on the top sides OS2, OS3 of the battery modules 2, 3. To fasten the cabling plate 8 to the retaining element 6, the cabling plate 8 is moved from above the top side 16 of the retaining element 6 towards the retaining element 6 and/or the battery modules 2, 3 in relation to the position of use of the battery module assembly 1 shown in FIGS. 1 and 13 until the cabling plate 8 is supported on the shoulder 17 of the retaining element 6 and/or the top sides OS2, OS 3 of the battery modules 2, 3.

As shown in FIGS. 12 and 13, the cables 10 of the low-voltage cabling 11 are attached to the grooves 9 of the cabling plate 8 and held form-fittingly in the grooves 9. The plugs 13 of the low-voltage cabling 11 are connected through the recesses 45 of the cabling plate 8 to the connections 12 provided for this purpose on the circuit board 5 of the battery monitoring unit 4. The cables 10 can be fixed in the area of the plugs 13 at the grooves 47 in the holes 48 connecting the recesses 45 and at the through-opening 50 by means of cable ties not shown.

A cable loop of the first module level M can be aligned by the positioning element 53 centrally below the opening of the bottom 46 of the tray housing 59 of the second module level. The cable of the cable loop can be routed through the opening when the second module level is arranged on the first module level.

FIG. 14 shows a cabling plate 8 of a second embodiment of the battery module assembly 1 shown in FIGS. 1 to 13. The same reference symbols are used for identical components or elements. The cabling plate 8 shown in FIG. 14 differs from the cabling plate 8 shown in FIGS. 1 to 13 in that the cabling plate 8 shown in FIG. 14 is designed for three battery modules. A third battery module is arranged next to the second battery module 3. A further retaining element 58 with a battery monitoring unit 4 is arranged between the second battery module 2 and the third battery module, which is not shown. The cabling plate 8 has recesses 45 for the passage of plugs 45 of the low-voltage cabling 11 and is also form-fittingly supported on the further retaining element 58. In addition, the cabling plate 8 has a length L 8 that is adapted to the length of the battery modules arranged next to each other. In addition, the cabling plate 8 has further grooves 9 for the cables connected to the battery monitoring unit 4 on the further retaining element 58. The side elements 31 of the second embodiment of the battery module assembly 1 have further coupling sections 32 for form-fitting connection to the further retaining element 58 and a length L 31 adapted to the length of the battery modules arranged next to one another.

All features explained in connection with individual embodiments of the invention can be provided in different combinations for the battery module assembly 1 or the assembly method for the battery module assembly 1 in order to realize their advantageous effects, even if these have been described for different embodiments. For example, the battery module assembly 1 can have six battery modules 2, 3 and three retaining elements 6, 58 arranged between the battery modules 2, 3, whereby two of the cabling plates 8 shown in FIG. 14 are form-fittingly supported on the retaining elements 6, 58.

### LIST OF REFERENCE SIGNS

1 Battery module assembly
2 First battery module
3 Second battery module
4 Battery monitoring unit
5 Circuit board
6 Retaining element
7 Receptacle (recess)
8 Cabling plate
9 Guide (groove)
10 Cable
11 Low-voltage cabling
12 Electronic component (connection)
13 Plug for the low-voltage cabling (transfer plug)
14 Gap
15 Protrusion of the circuit board
16 Top side of the retaining element
17 Shoulder of the first retaining element
18 Recess in the cabling plate
19 Contact surface
20 Outer surface
21 Locking element (arc)
22 Bottom of the groove
23 Side wall of the groove
24 Wave
25 First side surface of the cabling plate
26 Second side surface of the cabling plate
27 First support element
28 Second support element
29 Web
30 Support section
31 Side element
32 Coupling section (groove)
33 H-profile
34 Inside of the side element
35 Form-fitting section (spring)
36 Front surface of the retaining element
37 Tongue-and-groove connection
38 Reinforcing rib
39 Outside of the side element
40 Receptacle (groove) of the side element
41 Busbar
42 High-voltage connection
43 Rib
44 Busbar plug
45 Recesses of the cabling plate
46 Bottom of the tray housing
47 Groove for cable ties
48 Hole for cable tie
49 Edge of the recess
50 Through-opening
51 Material taper
52 Edge area of the cabling plate
53 Positioning element
54 Web of the positioning element
55 Retaining section of the positioning element
56 Hole the retaining section
57 Slot of the retaining section
58 Further retaining element
59 Tray housing
60 Recess
61 Transverse side of the retaining element
62 Bottom side of the retaining element
B6 Width of the retaining element
B8 Width of the cabling plate
B31 Width of the side element
D6 Thickness of the retaining element
D8 Thickness of the cabling plate
D31 Thickness of the side element
G Basic plane of the battery module assembly
H Main axis of the retaining element
L6 Length of the retaining element
L8 Length of the cabling plate
L31 Length of the side element
L38 Length of the reinforcing rib
LH Longitudinal axis of the retaining element
LS2 Longitudinal side of the first battery module
LS3 Longitudinal side of the second battery module
LV Longitudinal axis of the cabling plate
LW Longitudinal axis of the tray housing
M First module level
OS2 Top side of the first battery module
OS3 Top side of the second battery module
QS2 Transverse side of the first battery module
QS3 Transverse side of the first battery module
US2 Bottom side of the first battery module
US3 Bottom side of the second battery module

1. Battery module assembly with
a first battery module (2) and a second battery module (3), each comprising one or more battery cells,
a battery monitoring unit (4),
a retaining element (6) with a receptacle (7) in which the battery monitoring unit (4) is arranged,
wherein the retaining element (6) is arranged between the first battery module (2) and the second battery module (3),
a cabling plate (8) supported in a form-fitting manner on the retaining element (6) with guides (9) for holding cables (10) of a low-voltage cabling (11) for the battery monitoring unit (4).

2. The battery module assembly according to claim 1,
characterized in
that the retaining element (6) is arranged between a longitudinal side (LS2) of the first battery module (2) and a longitudinal side (LS3) of the second battery module (3), and
that the cabling plate (8) is arranged on an upper side (OS2, OS3) extending transversely to the longitudinal sides (LS2, LS3) of at least one of the battery modules (2, 3).

3. The battery module assembly according to claim 2,
characterized in
that at least one side element (31) is arranged on a transverse side (QS2, QS3) of at least one of the battery modules (2, 3) extending transversely to the longitudinal sides (LS2, LS3) and the top side (OS2, OS3) and is supported in a form-fitting manner against the retaining element (6).

4. The battery module assembly according to claim 3,
characterized in
that the at least one side element (31) has, on an outer side (39) facing away from the retaining element (6), at least one receptacle (40) for inserting a busbar (41) for a high-voltage connection (42) between the battery modules (2, 3).

5. The battery module assembly according to one of claims 1 to 4,
characterized in
that the guides of the cabling plate (8) are each formed as grooves (9) of the cabling plate (8), wherein several locking elements (21) are arranged at a distance from each other along the grooves (9) for form-fitting retention of the cables (10), which protrude beyond the grooves (9).

6. The battery module assembly according to one of claims 1 to 5,
characterized in
that the cabling plate (8) has at least one recess (45) for receiving an electrical connector (13) of the low-voltage cabling (11).

7. The battery module assembly according to one of claims 1 to 6,
characterized in that
holes (48) are drilled in the cabling plate (8) for fixing cable ties.

8. The battery module assembly according to one of claims 1 to 7,
characterized by a third battery module, wherein a further retaining element (58) with a battery monitoring unit (4) is arranged between the second battery module and the third battery module and the cabling plate (8) is supported in a form-fitting manner on both retaining elements (6, 58).

9. The battery module assembly according to one of claims 1 to 8,
characterized in
that the cabling plate (8) has a positioning element (53) in an edge region (52) for aligning a cable loop of the low-voltage cabling (11) with an opening of a cover arranged above the cabling plate (8).

10. The battery module assembly according to one of claims 1 to 9,
characterized in
that a first module level (M) comprises the battery modules (2, 3), the retaining elements (6, 58), the cabling plate (8) and/or the side element (31), wherein a second module level is arranged on the first module level (M).

11. The battery module assembly according to one of claims 1 to 10,
characterized in
that the retaining elements (6, 58), the cabling plate (8) and/or the side element (31) are made of a foamed plastic, in particular of expanded polypropylene (EPP).

12. An assembly method for a battery module assembly comprising the steps of:
Mounting a first battery module (2) and a second battery module (3) in series along a longitudinal axis (LW), so that a gap (14) is formed between the first battery module (2) and the second battery module (3),
Fastening the battery monitoring unit (4) in a receptacle (7) of a retaining element (6),
Insert the retaining element (6) with the battery monitoring unit (4) into the gap (14),
Fastening a cabling plate (8) on the retaining element (6), wherein the cabling plate (8) is supported in a form-fitting manner on the retaining element (6),
Fastening cables (10) of a low-voltage cabling system (11) for the battery monitoring unit (4) to guides (9) of the cabling plate (8), wherein the cables (10) are held in the guides (9).
characterized in
that the retaining element (6) is inserted between a longitudinal side (LS1) of the first battery module (2) and a longitudinal side (LS2) of the second battery module (3), and that the cabling plate (8) is arranged on an upper side (63) extending transversely to the longitudinal sides (LS 1, LS 2) of at least one of the battery modules (2, 3).

14. The method according to claim 12 or 13,
characterized in
that before fastening the cabling plate (8), at least one side element (31) is arranged on a transverse side (64) extending transversely to the longitudinal sides (LS1, LS2) and the top side (63) of at least one of the battery modules and is supported in a form-fitting manner against the retaining element (6).

15. The method according to one of claims 12 to 14,
characterized in
that before fastening the side element (31), a busbar (41) for electrically connecting the battery modules (2, 3) is inserted into a receptacle (40) of the side element (31) arranged on an outer side (39) facing away from the retaining element (6).
